(19) United States
(12) Patent Application Publication
(10) Pub. No.: US 2006/0180682 A1
(43) Pub. Date: Aug. 17, 2006

(54) Nozzle particularly for atomizing a liquid

(75) Inventors: Flavio Burato, Fara Vicentino (IT); Fabio Durighel, Montebelluna (IT); Silvio Gusmini, Treviglio (IT)

Correspondence Address: GREER, BURNS & CRAIN, 300 S WACKER DR, 25TH FLOOR, CHICAGO, IL, 60606, US

(73) Assignee: Riversdale Investments Limited

(21) Appl. No.: 11/190,713

(22) Filed: Jul. 27, 2005

(30) Foreign Application Priority Data
Jan. 31, 2005 (IT) TV2005A000015

(51) Int. Cl. B05B 1/14

(52) U.S. Cl. 239/552; 239/596; 239/600

(57) ABSTRACT

A nozzle particularly for atomizing a liquid, comprising a cylindrical body provided with a first axial channel for feeding the liquid and with second axial channels for feeding air, a covering element being associable with the cylindrical body. A hollow dome protrudes from the cylindrical body and is connected to the first channel and to an upper opening; a shank protrudes radially from the dome and has a plurality of ducts connected to the second channels. The covering element is shaped approximately complementarily to the dome, so as to form a chamber that is connected to the outside through a plurality of holes and/or lateral slots.

The present invention relates to a nozzle particularly for atomizing a liquid.

### BACKGROUND OF THE INVENTION

Currently, devices for atomizing a liquid use nozzles in which said liquid is mixed with air and the mixture is then dispensed in the form of minute droplets (atomization).

These known types of nozzle are for example mounted on guns, known as atomizer guns, of a known type, which are used for example to spray uniformly a coating on a product to be painted or to dispense an electrically charged tanning liquid in a device for tanning the human body.

Known types of nozzle are substantially constituted by a cylindrical body provided with a first axial channel for feeding said liquid and with second axial channels for feeding the air to be mixed with said liquid.

These first and second axial channels enter a mixing chamber, which is formed by a covering element that is substantially dome-shaped and is connected to the outside by means of a single very small axial hole.

The liquid and the air, introduced in the mixing chamber at a pressure that is higher than the ambient pressure, make contact with each other and mix, and the resulting mixture is then dispensed through said hole in the form of minute droplets.

The main drawback of these known types of nozzle is that they do not allow to adjust the breadth of the angle of the jet of dispensed mixture.

Another drawback of known types is that since the pressures required to allow the formation and dispensing of the mixture are rather high, the drops that form are therefore very small and can cause problems, for example if said drops have to be charged electrically, such as for example in the case of devices for tanning the human body.

### SUMMARY OF THE INVENTION

The aim of the present invention is to solve the above-mentioned problems, eliminating the drawbacks of the cited background art, by providing an invention that allows to mix a liquid with air and to dispense said mixture, in the form of droplets, with a jet having a selected angular breadth.

Within this aim, an object of the present invention is to provide an invention that allows to mix a liquid with air and to dispense the resulting mixture while maintaining the values of the pressure of the liquid and of the air within chosen ranges, so as to obtain droplets of a selected size.

Another object of the invention is to allow easy association with known types of device for atomizing a liquid, such as for example known atomizing guns.

Another object is to provide an invention that is structurally simple and has low manufacturing costs.

This aim and these and other objects that will become better apparent hereinafter are achieved by a nozzle particularly for atomizing a liquid, comprising a cylindrical body provided with a first axial channel for feeding said liquid and with second axial channels for feeding air, a covering element being associable with said cylindrical body, characterized in that said cylindrical body comprises a hollow dome, which is connected to said first channel and to an upper opening, from which a shank protrudes radially, said shank having a plurality of ducts connected to said second channels, said covering element being shaped approximately complementarily to said dome so as to form a chamber that is connected to the outside through a plurality of holes and/or lateral slots.

### BRIEF DESCRIPTION OF THE DRAWINGS

Further characteristics and advantages of the invention will become better apparent from the following detailed description of a particular but not exclusive embodiment thereof, illustrated by way of non-limiting example in the accompanying drawings, wherein:

FIG. 1 is an exploded perspective view of a nozzle according to the invention;

FIG. 2 is a longitudinal sectional view of the nozzle of FIG. 1;

FIG. 3 is a plan view of the covering element of a nozzle according to the invention;

FIG. 4 is a sectional view, taken along the line IV-IV of FIG. 3;

FIG. 5 is a plan view of the dome of a nozzle according to the invention;

FIG. 6 is a sectional view, taken along the line VI-VI of FIG. 5;

FIG. 7 is an exploded perspective view of a nozzle according to the invention.

### DESCRIPTION OF THE PREFERRED EMBODIMENTS

In the embodiments that follow, individual characteristics, given in relation to specific examples, may actually be interchanged with other different characteristics that exist in other embodiments. Moreover, it is noted that anything found to be already known during the patenting process is understood not to be claimed and to be the subject of a disclaimer.

With reference to the figures, the reference numeral 1 designates a nozzle particularly for atomizing a liquid, not shown in the accompanying figures.

The nozzle 1 comprises a cylindrical body 2, from which a plate 3 protrudes radially, said plate being shaped approximately like a prism having a hexagonal base, from the first lower end face 4 of which there protrudes, approximately at right angles thereto, a preferably cylindrical and hollow pin 5 for fixing the cylindrical body 2 to a device for atomizing a liquid, of a known type, such as for example an atomizer gun, not shown in the accompanying figures.

A cylinder 7 protrudes from the second upper end face 6 of the plate 3 and has a threaded outer lateral surface 8.

The cylindrical body 2 is provided with a first axial channel 9 for feeding said liquid, which passes longitudinally through the pin 5, the plate 3 and the cylinder 7.

The cylindrical body 2 is further provided with second axial channels 10 for feeding air, which pass longitudinally through the plate 3 and the cylinder 7 in a region located laterally with respect to the first channel 9.

A first cylindrical element 12 protrudes from the third upper end face 11 of the cylinder 7, approximately centrally thereto, and is internally hollow and connected to the first channel 9, which has a smaller diameter than the third end face 11, and is followed or continued by a shank 13, which has a transverse cross-section that is advantageously but not necessarily rectangular and has an outside diameter that is smaller than the diameter of the third end face 11 of the cylinder 7.

A plurality of through ducts 14 are provided on the shank 13, are connected to the second channels 10, and are advantageously distributed so as to be approximately mutually equidistant on the shank 13; preferably but not necessarily, the ducts 14 are provided along axes that are inclined with respect to the longitudinal axis of the shank 13, assuming, as shown in FIG. 7, an overall, substantially helical configuration.

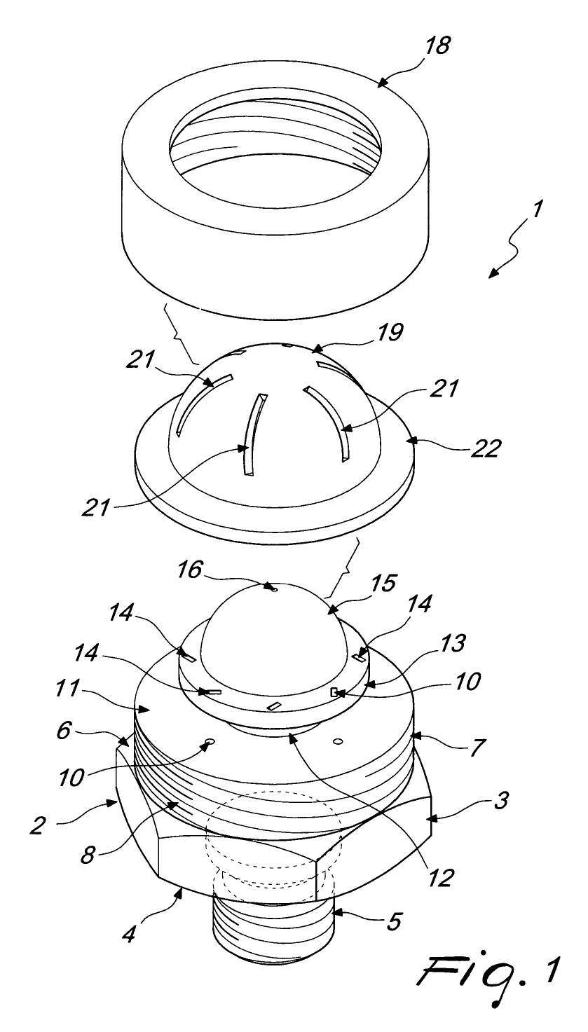

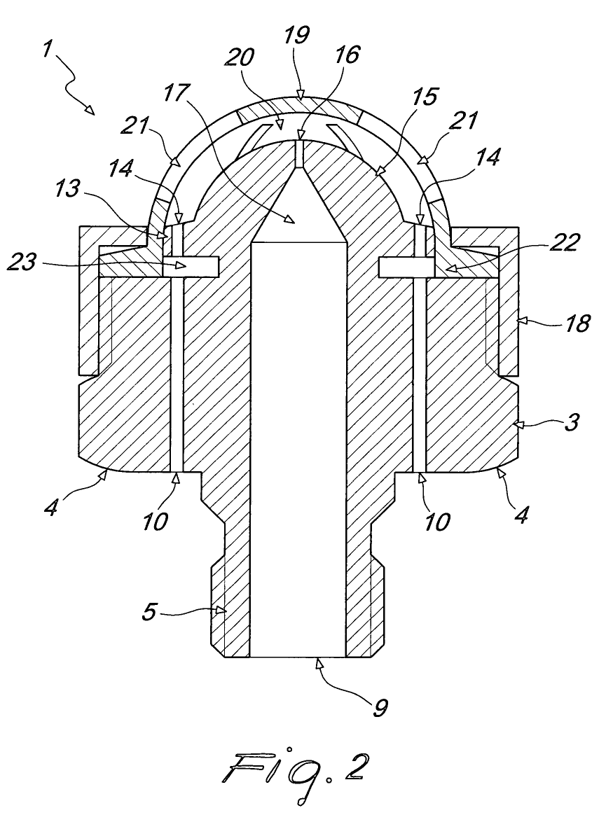

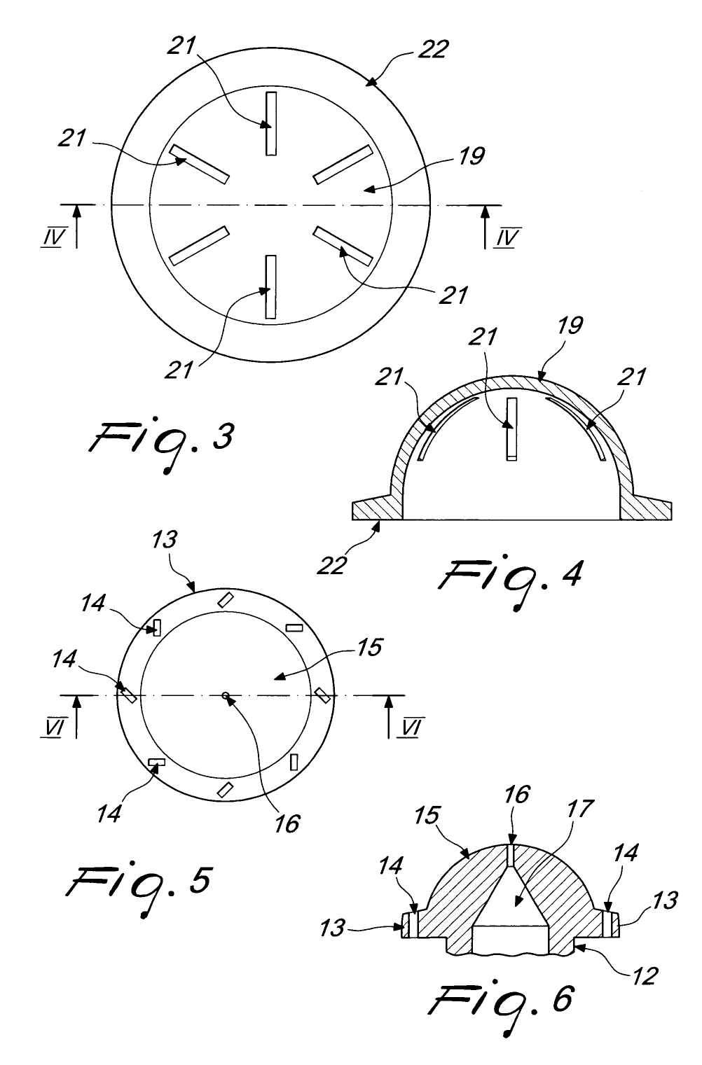

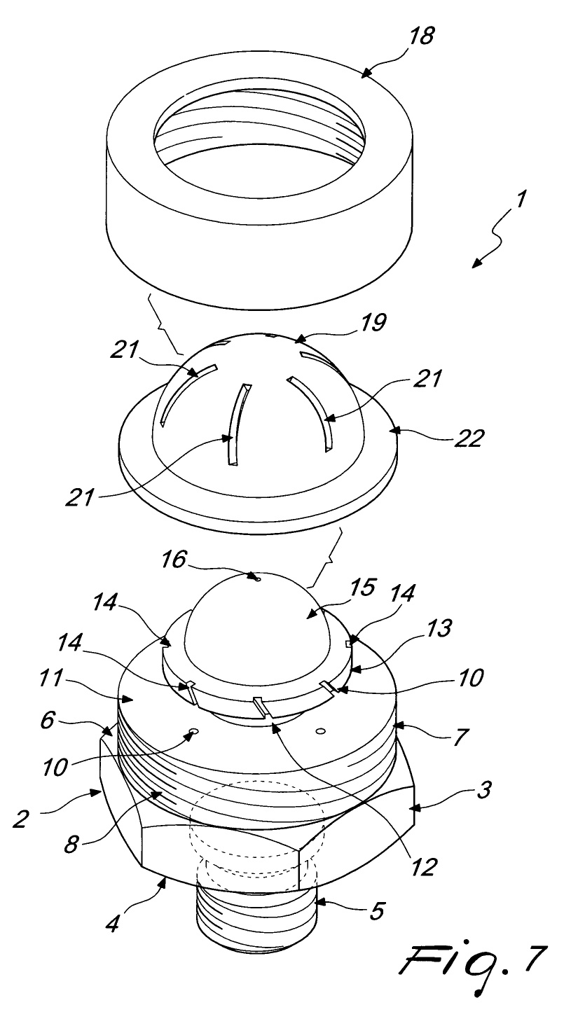

The ducts 14 can be provided, as shown in FIGS. 1, 2, 5 and 6, at and inside the shank 13 or, as an alternative, as shown in FIG. 7, they can be provided starting from the outside lateral surface towards its central axis, along part of respective diameters of said shank, and along axes that are inclined with respect to a corresponding generatrix.

The shank 13 protrudes radially from the lower end of a dome 15, which is advantageously hemispherical and hollow and has an upper opening 16 that is connected to the first channel 9 and is suitable to allow the liquid to escape from the dome 15.

The dome 15 is in fact provided internally with a cavity 17, which is connected to the inside of the first cylindrical element 12 and therefore to the first channel 9, which preferably but not necessarily tapers toward the upper opening 16 and is thus substantially frustum-shaped.

A covering element 19 is detachably associated with the cylindrical body 2 at the third end face 11 by way of known fixing means, such as for example a ring 18 that can be associated with the complementarily threaded lateral surface 8 of the cylinder 7; said covering element is advantageously shaped approximately complementarily with respect to the dome 15, and a chamber 20 is formed between the covering element 19 and the dome 15 and is connected to the outside through a plurality of lateral outlet slots 21.

Advantageously, the outlet slots 21 are distributed so that they are approximately mutually equidistant on the lateral surface of the covering element 19 and do not affect the region of the covering element 19 that faces the underlying upper opening 16 provided in the dome 15, i.e. such region of the covering element 19, remains free of openings.

Advantageously, outlet holes may also be provided in the covering element 19.

An annular protrusion 22 protrudes from the outer lateral surface of the covering element 19 approximately at the lower perimetric edge thereof and has an outside diameter that is substantially equal to the diameter of the third end face 11 of the cylinder 7.

An annular chamber 23 is formed between the lower surface of the shank 13, the third end face 11 and the internal lateral surface of the covering element 19 and connects the second channels 10 and the ducts 14.

The ring 18 locks the annular protrusion 22 of the covering element 19 to the third end face 11.

Operation is therefore as follows: with reference to FIG. 1, the covering element 19 rests on the third end face 11 and is fixed to the cylinder 7 by way of the ring 18.

The nozzle 1 can then be applied to a known type of device for atomizing a liquid, which is capable of sending said liquid under pressure to the first channel 9 and the pressurized air to the second channels 10.

The liquid passes through the first channel 9 and the cavity 17 and then, through the upper opening 16, is injected into the chamber 20, colliding with the region of the covering element 19 that faces the upper opening 16 and then descending again toward the shank 13.

At the same time, the air is guided into the annular chamber 23 through the second channels 10 and is then propelled into the ducts 14 and, by traveling through them, assumes a rotary motion and enters the chamber 20.

In the chamber 20 that constitutes a mixing chamber, the air makes contact with the liquid and mixes with it; the pressures of the air and the liquid are balanced at a value that is not much higher than the ambient pressure and therefore the mixture flows out of the nozzle 1, through the slots 21 or other holes, in the form of minute droplets at a pressure that is not much higher than the ambient pressure.

The higher the pressure of the air in relation to the pressure of the liquid, the more the mixture tends to flow out of the slots 21 toward the upper end of the covering element 19.

Therefore, for high values of the ratio between the pressure of the air and the pressure of the liquid, the jet of mixture that is dispensed has a narrow angle and vice versa for low values of said ratio the jet has a wide angle.

By acting on the ratio between the pressures of the liquid and of the air it is therefore possible to obtain a jet having a chosen angle breadth.

It has thus been found that the invention has achieved the intended aim and objects, a nozzle particularly for atomizing a liquid having been obtained which allows to adjust with continuity the breadth of the angle of the jet of the mixture of liquid and air that is dispensed.

Further, the nozzle according to the invention allows to dispense a mixture of liquid and air in the form of droplets whose dimensions remain within a selected range, further reducing the pressure at which said droplets are dispensed.

Moreover, the nozzle according to the invention can be applied easily to common devices for atomizing a liquid of a known type, such as for example atomizer guns.

Further, the production costs of the nozzle according to the invention remain low, since it is constituted exclusively by components that are easy to manufacture and/or assemble.

The invention is of course susceptible of numerous modifications and variations, all of which are within the scope of the appended claims.

The materials used, as well as the dimensions of the individual components of the invention may of course be more pertinent according to specific requirements.

The various means for performing certain different functions need not certainly coexist only in the illustrated embodiment but can be present per se in many embodiments, including ones that are not illustrated.

The characteristics indicated as advantageous, convenient or the like might also be omitted or be replaced with equivalents.

The disclosures in Italian Patent Application No. TV2005A000015 from which this application claims priority are incorporated herein by reference.

What is claimed is:

1. A nozzle for atomizing a liquid, comprising: a cylindrical body provided with a first axial channel for feeding a liquid and with second axial channels for feeding air; a covering element associable with said cylindrical body; a hollow dome, which is connected to said first channel; an upper opening, formed at said dome; a shank that protrudes radially from said dome, said shank having a plurality of ducts connected to said second channels, said covering element being shaped complementarily to said dome so as to form a chamber therewith; and a plurality of outlet holes and/or lateral slots formed at said covering element.

2. The nozzle of claim 1, further comprising: a cylindrical body; a plate protruding radially from the cylindrical body; a cylindrical and hollow pin for fixing to a device for atomizing a liquid, said pin protruding from a first lower end face of said plate, substantially at right angles thereto; a cylinder protruding from a second upper end face of said plate and having a threaded outer lateral surface; a first, internally hollow, cylindrical element protrudes from a third upper end face of said cylinder, substantially centrally thereto, is connected to said first channel, has a smaller diameter than said third upper end face, said shank protruding in continuation of said cylindrical element, and having an outside diameter that is smaller than a diameter of said third end face of said cylinder.

3. The nozzle of claim 1, wherein said through ducts are formed on said shank, are connected to said second channels and are distributed so as to be mutually equidistant.

4. The nozzle of claim 3, wherein said ducts are formed along axes that are inclined at least with respect to a longitudinal axis of said shank.

5. The nozzle of claim 4, wherein said ducts assume an overall, substantially helical configuration.

6. The nozzle of claim 2, wherein said shank protrudes radially from the lower end of said dome, which is hemispherical and hollow, and is provided with said upper opening, which is connected to said first channel, said dome being provided internally with a cavity connected to an inside of said first cylindrical element and to said first channel.

7. The nozzle of claim 6, further comprising a ring, said covering element, shaped complementarily with respect to said dome, being detachably associated with said cylindrical body at said third end face by way of said ring that is associatable with the complementarily threaded lateral surface of said cylinder.

8. The nozzle of claim 7, wherein said chamber is formed between said covering element and said dome and is provided with an outside connection through said plurality of said lateral slots or holes.

9. The nozzle of claim 8, wherein said slots or holes are distributed equidistant on a lateral surface region of said covering element.

10. The nozzle of claim 9, comprising: an annular protrusion that protrudes from the outer lateral surface of said covering element, at a lower perimetric edge thereof, said annular protrusion having an outside diameter that is substantially equal to a diameter of said third end face of said cylinder; and an annular chamber formed between a lower surface of said shank, said third end face and the inner lateral surface of said covering element and connecting said second channels and said ducts.

11. The nozzle of claim 5, wherein said ducts are formed at and inside said shank.

12. The nozzle of claim 5, wherein said ducts are formed starting from a lateral surface, and along part of a corresponding diameter, of said shank along an axis that is inclined with respect to a generatrix thereof.
